(19) United States
(12) Patent Application Publication
(10) Pub. No.: US 2019/0090093 A1
(43) Pub. Date: Mar. 21, 2019

(54) SYSTEM AND METHOD FOR LOCATING A WIRELESS COMMUNICATION DEVICE

(71) Applicant: Huf North America Automotive Parts Manufacturing Corporation, Milwaukee, WI (US)

(72) Inventor: Antonio Odejerte, Jr., Farmington Hills, MI (US)

(73) Assignee: Huf North America Automotive Parts Manufacturing Corporation, Milwaukee, WI (US)

(21) Appl. No.: 15/766,385

(22) PCT Filed: Oct. 6, 2016
(86) PCT No.: PCT/US2016/055488

§ 371 Date: Apr. 6, 2018

Related U.S. Application Data
(60) Provisional application No. 62/237,637, filed on Oct. 6, 2015.

(51) Int. Cl. H04W 4/029; H04W 4/02; H04W 4/80; H04B 17/318; G07C 9/00; H04W 4/40

(52) U.S. Cl. CPC H04W 4/029; H04W 4/026; H04W 4/80; G07C 2009/00547; G07C 9/00007; H04W 4/40; H04B 17/318

(57) ABSTRACT

A method for determining a location of a vehicle access device relative to a vehicle includes transmitting information from the vehicle access device to the vehicle. The method also includes determining a received signal strength indication value of the vehicle access device. The method further includes transmitting the received signal strength indication value from a first wireless communication node to a second wireless communication node. The first and second wireless communication nodes are disposed on the vehicle. The method also includes comparing the received signal strength indication value of the vehicle access device to a received signal strength indication value of the first wireless communication node.

### FIELD

The present disclosure relates generally to a system and method for locating a wireless communication device and more particularly to a system and method for locating a wireless communication device using a wireless communication protocol.

### BACKGROUND

This section provides background information related to the present disclosure and is not necessarily prior art.

A wireless communication device, such as a smartphone, a smart watch, or a computer (e.g., a tablet, laptop, personal digital assistant, etc.), for example, can be used to communicate with a motor vehicle. For example, a wireless communication device can communicate with a vehicle in order to access, diagnose faults, start/stop, and/or provide power to certain components and/or systems within the vehicle. In particular, a user may utilize a wireless communication protocol (e.g., short-range radio wave communication, Wi-Fi, BLUETOOTH®, near field communication (NFC), etc.) to access and/or operate the vehicle. For example, the operator may access and/or operate the vehicle by utilizing a wireless communication protocol controlled and powered by a smartphone.

When utilizing a wireless communication device to access and/or operate a vehicle, communication between the wireless communication device and the vehicle can be adversely affected by various environmental factors and/or conditions such as the distance between the wireless communication device and the vehicle, weather conditions (e.g., clouds, rain, snow, etc.) at the location of the wireless communication device and/or the vehicle, the existence of any barriers (e.g., walls, buildings, people, clothing, etc.) between the wireless communication device and the vehicle, and the orientation of the wireless communication device relative to the vehicle, for example. These various environmental conditions can make it difficult to accurately determine the location of the wireless communication device relative to the vehicle. In particular, environmental conditions can make it difficult to accurately determine the distance between the wireless communication device and the vehicle

While known systems and methods for determining the location of, and/or distance between, a wireless communication device and a vehicle have proven acceptable for their intended use, such systems are typically sensitive to the various environmental conditions between, and surrounding, the wireless communication device and the vehicle. Such sensitivity to environmental conditions can make it difficult to accurately determine the location of, and/or distance between, the wireless communication device and the vehicle, which can, in turn, make it difficult to access and/or operate the vehicle with the wireless communication device.

### SUMMARY

This section provides a general summary of the disclosure, and is not a comprehensive disclosure of its full scope or all of its features.

According to one aspect, the present disclosure provides a system and method for determining a location of a vehicle access device. The system and method may improve the accuracy of determining a distance between the vehicle access device (e.g., a smartphone)—used as a device to access, diagnose, and/or start/stop a vehicle via a wireless communication protocol (e.g., Bluetooth® low energy)—and the vehicle. The system may include various wireless communication nodes and/or control modules in the vehicle and a wireless communication node and/or control module located within the vehicle access device.

In some configurations, the system and method may address various factors (e.g., weather) that can affect the ability of the vehicle access device to access the vehicle via the wireless communication protocol such as, for example, signal propagation characteristics of the wireless communication protocol that may operate at a frequency of 2.4 GHz, which is sensitive to environmental conditions (i.e. barriers, weather, etc.), a human body, antenna orientation, radio frequency characteristics of the vehicle access device, etc.

The system and method of the present disclosure may consistently improve the accuracy of distance approximation between the vehicle access device and the vehicle by using a received signal strength indication (RSSI) value of a signal transmitted from a wireless communication node of the vehicle access device.

The vehicle may include three wireless communication nodes, allowing the system to accurately determine the location of the vehicle access device in various possible environmental conditions. A first wireless communication node may be placed on a C-pillar of the vehicle. A second wireless communication node may be placed on a front door handle of the vehicle. In some configurations, the second wireless communication node may be placed on a driver's door handle of the vehicle. A third wireless communication node may be placed on a front door handle of the vehicle. In some configurations, the third wireless communication node may be placed on a passenger's door handle of the vehicle. The location of the second and third wireless communication nodes may improve the ability of the system and method to detect the location of the vehicle access device relative to the vehicle.

In some configurations, the vehicle access device may function as a central and/or master wireless communication node. In other configurations, the vehicle access device may function as a peripheral and/or slave wireless communication node.

The vehicle access device and the vehicle may share a common secret key that can be used to encrypt/decrypt the exchange of wirelessly communicated information between the vehicle access device and the vehicle.

The vehicle access device may advertise for Bluetooth® low energy (BLE) packets. The first wireless communication node of the vehicle may search and/or scan in a pre-defined scanning interval and window for the BLE packets. The second and third wireless communication nodes of the vehicle may be deactivated or may be in a sleep mode.

The end user may reserve the vehicle, such that the end user is permitted to access the vehicle. The end user may activate one or more applications on the vehicle access device for using the vehicle. The vehicle access device, including the wireless communication node, may begin advertising secured BLE packets. The vehicle may receive confirmation via telematics about the vehicle access device and may begin scanning for the BLE packets transmitted from the vehicle access device. Once the vehicle access device is within a detection range of the first wireless communication node of the vehicle, and once an exchange of an authentication sequence to determine whether the vehicle access device is permitted to access the vehicle is performed, the wireless communication node of the vehicle access device may be linked and/or wirelessly bonded to the first wireless communication node of the vehicle.

The first wireless communication node may send a wake-up message to the second and third wireless communication nodes via mesh BLE communication or wired communication. The first wireless communication node may send a wake-up message to a body control module of the vehicle. The first wireless communication node may also send a command to the second and third wireless communication nodes to perform a calibration strategy.

The output of the calibration strategy may be RSSI values, corresponding to the second and third wireless communication nodes that can be used by the first wireless communication node to approximate a location of the vehicle access device in a particular environmental condition. The first wireless communication node may also send information to the second and third wireless communication nodes corresponding to the identity of the connected vehicle access device.

In some configurations, the RSSI values from the second and third wireless communication nodes may be stored in a memory of each of the second and third wireless communication nodes.

While the vehicle access device is connected to the first wireless communication node, the first wireless communication node may request via a generic attribute profile for the vehicle access device to advertise BLE packets and also transmit the vehicle access device's current transmit power level that is used in advertising the BLE packets. After the current transmit power level is received by the first wireless communication node, the current transmit power level may be sent to the second and third wireless communication nodes. In addition, the first wireless communication node may instruct the second and third wireless communication nodes to start scanning for the BLE packets transmitted from the vehicle access device. The second and third wireless communication nodes may perform a filtering and/or smoothing algorithm to determine an accurate RSSI value that can be used to approximate the distance between the vehicle access device and the vehicle. The RSSI value may be sent continuously to the first wireless communication node as one factor to be considered in a localization strategy.

While the second and third wireless communication nodes are scanning and performing the filtering and/or smoothing algorithm to the RSSI value transmitted from the vehicle access device, the first wireless communication node may request the vehicle access device to send linear and/or angular acceleration and/or velocity values from an accelerometer and/or gyroscope disposed on or associated with the vehicle access device. The values received from the accelerometer and/or the gyroscope may be used to determine the movement and/or orientation of the vehicle access device. For example, these values may be used to determine whether the vehicle access device is moving towards the vehicle or moving away from the vehicle. The values received from the accelerometer and/or the gyroscope may also be used to determine the orientation of the vehicle access device with respect to the vehicle. The orientation may help the vehicle to know whether a BLE antenna of the vehicle access device is facing toward or away from the vehicle.

After the first wireless communication node receives the values from the accelerometer and/or the gyroscope, the first wireless communication node may request the vehicle access device to provide weather conditions and/or a current location of the vehicle access device based on an embedded feature of the vehicle access device. The location information may not include raw coordinates of the vehicle access device but, rather, may instead include an indication based on the derived data from the vehicle access device of whether the vehicle is located outdoors or indoors.

In some aspects, the system and method may include an adaptation strategy for determining the location of the vehicle access device in an actual environmental condition. In some configurations, the first wireless communication node may store a lookup table that shows the relationship between the RSSI value and an approximate distance between the vehicle and the vehicle access device based on a particular environmental condition. For example, if the vehicle is parked outdoors, the telematics may continuously send—in a pre-defined interval—the location of the vehicle and, also, the status of an ignition of the vehicle. When the vehicle is in a park mode, the telematics may send location information to the first wireless communication node where may be stored on an internal memory of the first wireless communication node.

According to another aspect, the present disclosure provides a system and method for calibrating a vehicle communication system. Once the ignition of the vehicle is OFF, the first wireless communication node may instruct the second and third wireless communication nodes to perform a calibration method. The first wireless communication node may instruct the second wireless communication node to advertise a pre-defined BLE packet while the third wireless communication node performs a scanning operation. The third wireless communication node may gather RSSI values based on the BLE packets sent by the second wireless communication node. The third wireless communication node may also perform a filtering and/or smoothing operation on the RSSI value. The resultant RSSI value may be sent to the primary wireless communication node. The resultant RSSI value may also be stored on the internal memory of the second wireless communication node for use by an inside/outside detection algorithm.

After the RSSI value from third wireless communication node is received by the first wireless communication node, the first wireless communication node may instruct the second and third wireless communication nodes to reverse their roles. Specifically, the second wireless communication node may begin scanning for BLE packets, while third wireless communication node may begin advertising BLE packets. The second wireless communication node may filter and/or smooth an RSSI value. The resultant RSSI value may be sent to the first wireless communication node and/or stored on an internal memory of the second wireless communication node for use in an inside/outside detection algorithm.

Following the calibration method, the primary wireless communication node may instruct the second and third wireless communication nodes to deactivate and/or enter a sleep mode in order to conserve power. The primary wireless communication node may transition to a scanning mode to scan for BLE packets transmitted from the vehicle access device.

Once the vehicle access device has been detected, authenticated, and bonded to the primary wireless communication node, the primary wireless communication node may activate or wake the second and third wireless communication nodes and the body control module. The second and third wireless communication nodes may perform the calibration method a second time in order to determine whether the environmental situation has changed since the completion of the first calibration method to allow the system and method to adapt to the actual environmental conditions.

The primary wireless communication node may request from the vehicle access device the (i) current transmit power level, (ii) accelerometer and/or gyroscope values, and (iii) weather information. For example, if the vehicle is initially parked in a sunny area and it subsequently begins to precipitate (i.e., rain, snow, etc.), weather information from the vehicle access device and/or weather information received from a rain sensor associated with the vehicle may allow the first wireless communication node to dynamically adapt by using a different lookup table that corresponds to the particular weather conditions experienced by the vehicle. The rain sensor data may serve as a counter check mechanism to ensure that the weather information from the vehicle access device matches the actual environmental conditions experienced by the vehicle. For example, the weather information may indicate that it is raining, but the actual weather conditions experienced by the vehicle may be different (i.e., the actual weather conditions may reflect that the car is parked indoors). In this regard, there may be various look-up tables corresponding to various environmental conditions. Accordingly, an adaptive approach to the system and method for determining the location of the vehicle access device can mitigate the effect of weather conditions on the performance of the system and method.

In some configurations, the vehicle access device may be the master and the primary wireless communication node may be the slave. The second and third wireless communication nodes may act as advertisers. In such a configuration, the overall current consumption of the primary wireless communication node may be lower than a configuration in which the primary wireless communication node is scanning and/or otherwise functioning as the master. Moreover, operating the vehicle access device as the master may allow the system and method to support a larger variety of vehicle access devices (e.g., models of vehicle access devices). In addition, operating the vehicle access device as the master may simplify the development and operation of the vehicle. For example, the first, second, and third wireless communication nodes may have the same BLE address. The second and third wireless communication nodes may be differentiated from each other and from the first wireless communication node by assigning a different minor BLE address value to each of the second and third wireless communication nodes. With this approach, the vehicle access device—acting as the master—can incorporate a lookup table that groups the various wireless communication nodes on a specific vehicle. By using this same BLE address, but with specific major and minor values for the wireless communication nodes in a specific vehicle, the vehicle access device can determine which vehicle it should communicate with in a situation in which there is more than one vehicle located within a predetermined distance of the vehicle access device.

Once the end user with the vehicle access device is inside the vehicle and the door on the vehicle is closed, the first wireless communication node may instruct the second and third wireless communication nodes to perform a detection algorithm. The second and third wireless communication nodes may scan for BLE packets transmitted by the vehicle access device, and filter and/or smooth the RSSI values using a filtering and/or smoothing algorithm. The resultant RSSI values may be transmitted to the first wireless communication node. The RSSI values from the second and third wireless communication nodes may be compared—using an algorithm—to the RSSI values generated during the calibration method. The result of the algorithm can determine whether the vehicle access device is located inside or outside of the vehicle. If the vehicle access device is determined to be located outside of the vehicle, the end user may be prohibited from starting the engine of the vehicle.

According to another aspect, the present disclosure provides a system and method for communicating between a vehicle and a vehicle access device. The system may include various wireless communication nodes and/or control modules configured to permit wireless communication between the vehicle access device and the vehicle using various wireless communication protocols. For example, the system may include an ultra-high frequency (UHF) communication node, a BLE communication node, and a near field communication (NFC) node. The NFC node may be configured to operate at a low power level (e.g., a low battery charge level), such that the vehicle access device is operable to communicate with, and access, the vehicle when a battery of the vehicle access device has a low charge level.

The UHF communication node, the BLE communication node, and/or the NFC node may be disposed in a communication module. In this regard, the UHF communication node, the BLE communication node, and/or the NFC node may be disposed in the same communication module in order to reduce the material cost and/or packaging size.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected configurations and not all possible implementations, and are not intended to limit the scope of the present disclosure.

FIG. 1 is a functional block diagram of an example vehicle communication system according to the present disclosure;

FIG. 2 is another functional block diagram of the example vehicle communication system of FIG. 1;

FIGS. 3A and 3B are flowcharts depicting an example method of controlling a vehicle communication system according to the present disclosure;

FIG. 4 is a flowchart depicting another example method of controlling a vehicle communication system according to the present disclosure;

FIG. 5 is a flowchart depicting another example method of controlling a vehicle communication system according to the present disclosure; and

FIG. 6 is a functional block diagram of another example vehicle communication system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

The description provided herein is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory. Non-limiting examples of a non-transitory tangible computer readable medium include nonvolatile memory, volatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

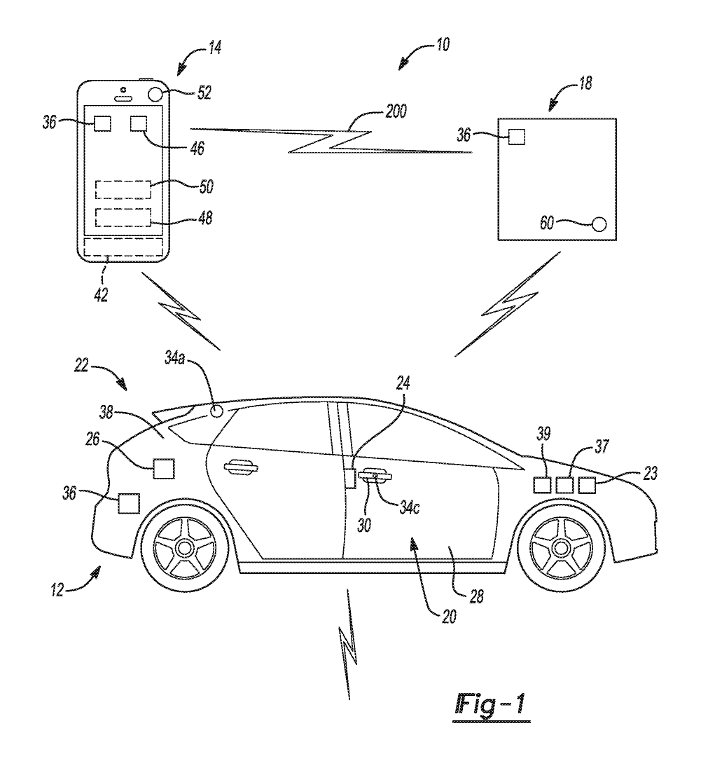

With reference to FIG. 1, a vehicle communication system 10 is provided. The vehicle communication system 10 may include a vehicle 12, a vehicle access device 14, and a vehicle control center 18. The vehicle 12 may be any known variety of motorized vehicle, such as a car, truck, or van, for example. In this regard, the vehicle 12 may be a private or commercial-type motor vehicle. In some configurations, the vehicle 12 may be one of a group of vehicles 12 that make up part of a fleet of vehicles, such as a fleet of rental vehicles or a fleet of commercial vehicles, such as delivery vehicles or service vehicles.

The vehicle 12 may include an access system 20, a communication system 22, and a body control module 23. The access system 20 may include one or more locks 24, a locking module 26, and one or more doors 28 and/or other access location(s). The locks 24 may permit and/or prevent access to the vehicle 12 through the doors 28. For example, each door 28 of the vehicle 12 may include a lock 24 and a handle 30. In particular, the locking module 26 may communicate with the lock(s) 24 to permit and/or prevent operation of the handle 30 in order to permit and/or prevent access to the vehicle 12 through the doors 28. In this regard, the locking module 26 may receive a signal from the vehicle access device 14 and control a state (e.g., locked or unlocked) of the lock(s) 24 based on the signal(s) received from the vehicle access device 14.

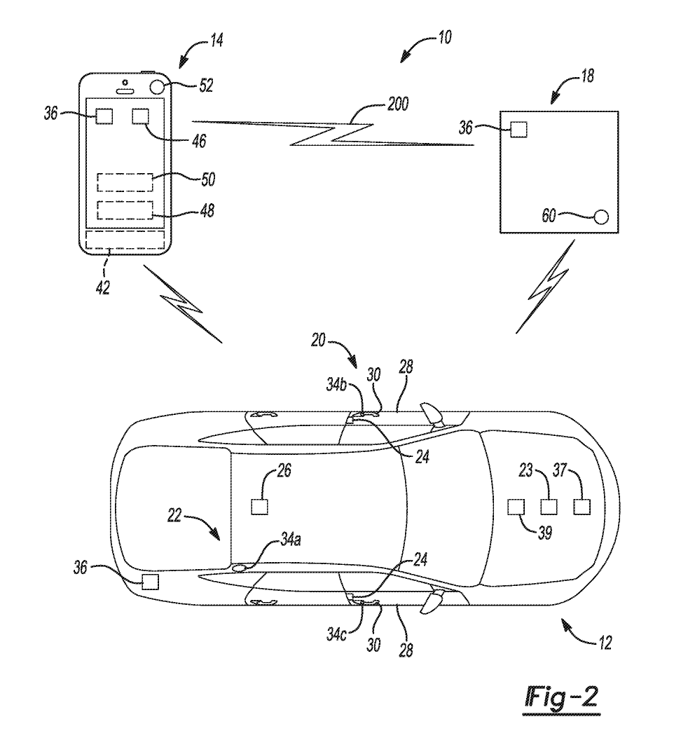

The communication system 22 may include one or more wireless communication nodes 34a-c, a communication application 36, and an infotainment system 37. For example, in some configurations, the communication system 22 includes three wireless communication nodes 34a-c. In particular, communication system 22 may include a primary wireless communication node 34a, a first secondary communication node 34b, and a second secondary communication node 34c. As illustrated in FIGS. 1 and 2, the communication nodes 34a-c may be located in various locations on and/or in the vehicle 12. For example, the primary wireless communication node 34a may be located on a body portion of the vehicle 12. In particular, in some configurations, the primary wireless communication node 34a may be located on a C-pillar 38 of the vehicle 12. The first and/or second communication nodes 34b, 34c, may each be located on one of the doors 28 of the vehicle 12. For example, in some configurations, the first secondary communication node 34b may be located on the door handle 30 on a driver's side of the vehicle 12, and the second secondary communication node 34c may be located on the door handle 30 on a passenger's side of the vehicle 12.

As will be explained in more detail below, each wireless communication node 34a-c may be configured to communicate with the other wireless communication node(s) 34a-c. For example, the wireless communication nodes 34a-c may communicate with one another, and with the vehicle access device 14, through one or more wired and/or wireless communication protocols, such as LIN Communication, short-range radio wave communication, Wi-Fi, BLUETOOTH®, and/or BLUETOOTH® low energy (BLE) (e.g., Mesh BLE). In this regard, the wireless communication nodes 34a-c may be referred to herein as BLE communication nodes 34a-c.

The BLE communication nodes 34a, 34b, 34c may each include a BLE address (e.g., a major BLE address). In some configurations, each BLE communication node 34a, 34b, 34c may include the same major BLE address. In this regard, the secondary BLE communication nodes 34b, 34c may each include a minor BLE address. The minor BLE address of the secondary BLE communication node 34b may be different than the minor BLE address of the secondary BLE communication node 34c. Accordingly, the minor BLE addresses can allow the secondary BLE communication nodes 34b, 34c to be differentiated from each other and from the primary BLE communication node 34a, which can help the vehicle access device 14 to determine which of the BLE communication nodes 34a, 34b, 34c to communicate with when there is more than one vehicle 12. In particular, the vehicle access device 14 may include a table that groups the BLE communication nodes 34a, 34b, 34c on a specific vehicle 12, such that using the BLE addresses, including the minor BLE addresses, can help the vehicle access device 14 to determine which of the BLE communication nodes 34a, 34b, 34c the vehicle access device 14 should communicate with when there is more than one vehicle 12.

The communication application 36 may allow the vehicle 12 to communicate with the vehicle access device 14 and/or with the vehicle control center 18. For example, the communication application 36 may implement a wireless communication protocol that allows the vehicle 12 to wirelessly send and receive messages to and/or from the vehicle access device 14 and/or the vehicle control center 18.

The infotainment system 37 may allow the vehicle 12 to communicate with a user. For example, the infotainment system 37 may include a display (not shown) and/or a speaker (not shown) that allow the infotainment system 37 to send visual and/or audible instructions to the user.

The body control module 23 may control various aspects of accessing and/or operating the vehicle 12. For example, the body control module 23 may communicate with the access system 20 and/or the communication system 22 in order to permit or prevent access to the vehicle 12 through the doors 28 and/or to permit or prevent access to the vehicle 12 via an engine (not shown) of the vehicle 12. For example, the body control module 23 may permit or prevent the vehicle access device 14 from operating the engine of the vehicle 12.

The vehicle access device 14 may include a mobile communication device such as a smartphone, a smart watch, or a computer (e.g., a tablet, laptop, personal digital assistant, etc.), for example. The vehicle access device 14 may include a battery 42, the communication application 36, an environment-monitoring application 46, a gyroscope 48, an accelerometer 50, and a wireless communication node 52. The environmental-monitoring application 46 may be configured to determine various environmental conditions at the location of the vehicle access device 14. For example, the environmental-monitoring application 46 may be a weather application configured to determine the temperature, humidity, and/or precipitation conditions at the location of the vehicle access device 14. The gyroscope 48 may be configured to determine an orientation of the vehicle access device 14. The accelerometer 50 may be configured to determine motion-related characteristics of the vehicle access device 14, such as speed, acceleration, and/or deceleration. As will be explained in more detail below, the wireless communication node 52 may be configured to communicate with the vehicle 12 and/or the vehicle control center 18. For example, the wireless communication node 52 may communicate with the wireless communication node(s) 34a-c, through one or more wireless communication protocols, such as short-range radio wave communication, Wi-Fi, BLUETOOTH®, and/or BLUETOOTH® low energy (BLE). In this regard, the wireless communication node 52 may be referred to herein as BLE communication node 52.

The vehicle control center 18 may include the communication application 36 and a wireless communication node 60. As will be explained in more detail below, the wireless communication node 60 may be configured to communicate with the vehicle 12 and/or the vehicle access device 14. For example, the wireless communication node 60 may communicate with the wireless communication node(s) 34a-c and/or 52 through one or more wireless communication protocols, such as short-range radio wave communication, Wi-Fi, BLUETOOTH®, and/or BLUETOOTH® low energy (BLE). In this regard, the wireless communication node 60 may be referred to herein as BLE communication node 60.

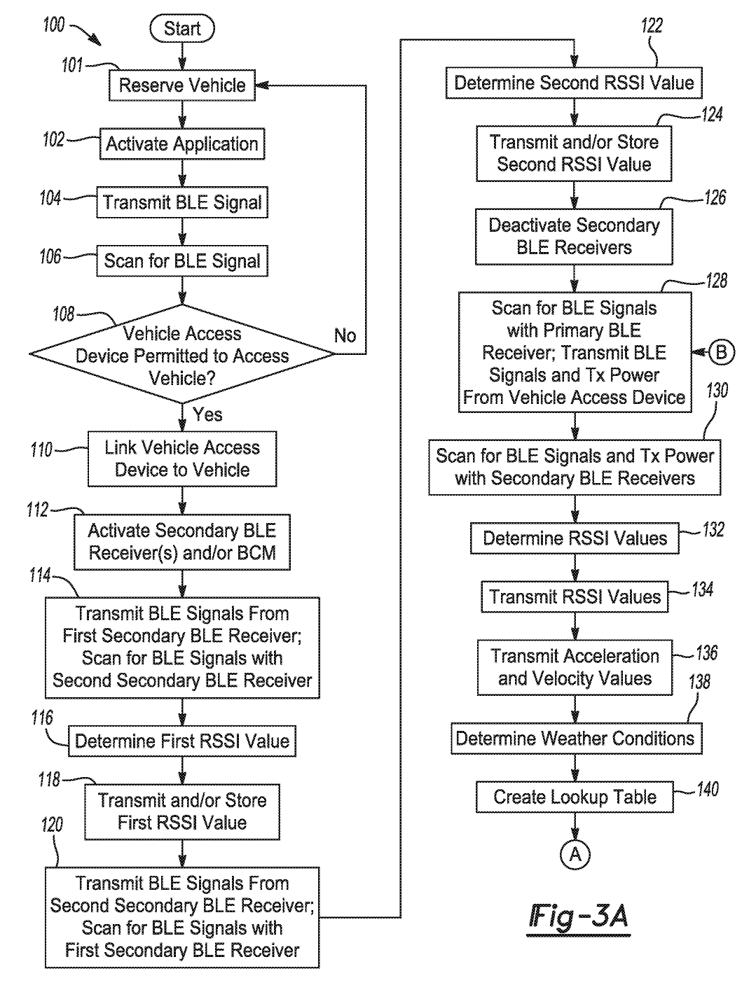

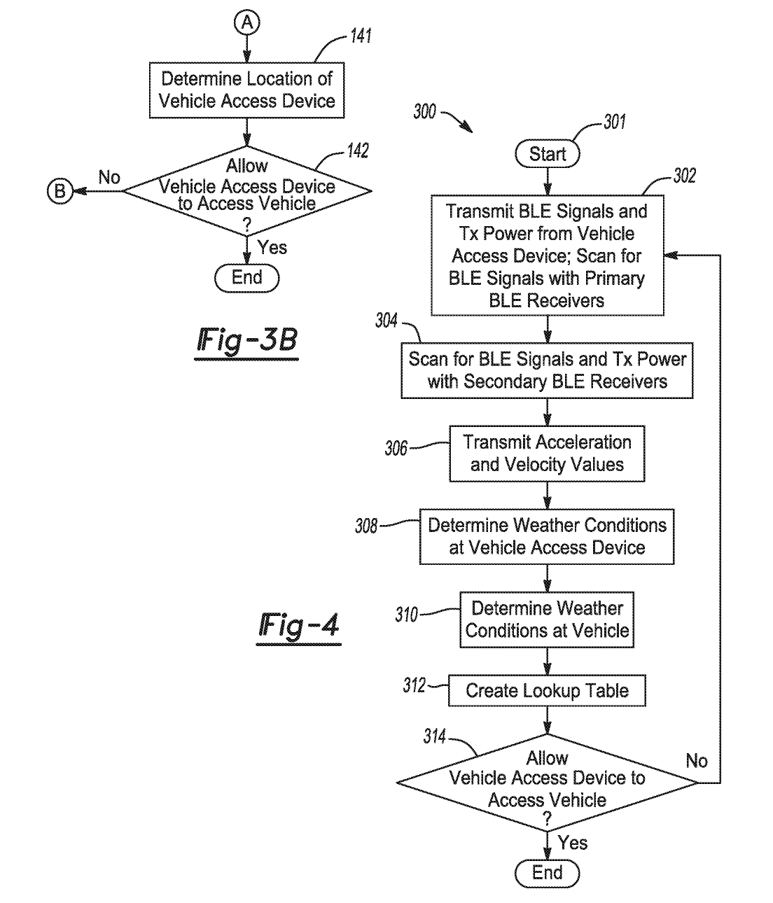

With reference to FIGS. 3A and 3B, a method for determining a position of the vehicle access device 14 relative to the vehicle 12, and/or determining whether to permit the vehicle access device 14 to access the vehicle 12, is illustrated at 100. As will be explained, the position of the vehicle access device 14 may include the location of the vehicle access device 14, the orientation of the vehicle access device 14, and/or the distance between the vehicle access device 14 and the vehicle 12.

At 101, an end user may reserve the vehicle 12. In particular, as used herein, the end user may be a party that receives, or has previously received, permission to use the vehicle 12. For example, in one implementation, the end user may be a party that has entered into a rental agreement for the vehicle 12 with the vehicle control center 18. In other implementations, the end user may be a party that has received permission to operate the vehicle 12 as an employee or a service provider, for example. The vehicle access device 14 may receive a signal 200 from the vehicle control center 18 allowing the end user to access the vehicle 12 using the vehicle access device 14. For example, the vehicle access device 14 may receive a signal allowing the vehicle access device 14 to change the state of the locks 24, the engine 30, and/or a starter (not shown) of the vehicle 12.

At 102, the end user may activate the communication application 36 to enable the vehicle access device 14 to communicate with the vehicle 12. In particular, activating the communication application 36 may allow the wireless communication node 52 to communicate with the wireless communication nodes 34a, 34b, and/or 34c.

At 104, the vehicle access device 14 may wirelessly transmit information from the wireless communication node 52. For example, the wireless communication node 52 may advertise BLE packets for reception by one or more of the other wireless communication nodes 34a, 34b, 34c.

At 106, the vehicle 12 may scan and/or search for wirelessly transmitted information. For example, one or more of the wireless communication nodes 34a, 34b, 34c may scan for BLE packets. In particular, the wireless communication node 34a, 34b, and/or 34c may scan in pre-defined intervals of time, and/or within a predefined period of time, for BLE packets advertised from the vehicle access device 14. In one configuration, at 106, the primary wireless communication node 34a may scan for BLE packets advertised from the vehicle access device 14 while the secondary communication nodes 34b, 34c may be deactivated (e.g., sleep mode).

It will be appreciated that, before and/or after scanning for BLE packets advertised from the vehicle access device 14, the vehicle 12 may request that the user place the vehicle access device 14 in a location and/or an orientation relative to the vehicle 12. For example, the infotainment system 37 may request that the user place the vehicle access device 14 within a detection range (e.g., a predefined distance) of one or more of the wireless communication nodes 34a, 34b, 34c. In this regard, in some implementations, the infotainment system 37 may send a visual and/or audio signal to the user requesting that the vehicle access device 14 be placed in a particular location and/or a particular orientation relative the vehicle 12. For example, the infotainment system 37 may request that the vehicle access device 14 be placed outside of a window of the door 28 (e.g., the driver's side door) of the vehicle 12 and/or oriented towards the vehicle 12 (e.g., horizontal, vertical, etc.) while the application 36 is activated.

At 108, the primary wireless communication node 34a of the vehicle 12 may determine whether the vehicle access device 14 has permission to access the vehicle 12. In this regard, once the vehicle access device 14, and/or the wireless communication node 52, is within the detection range (e.g., a predefined distance) of the vehicle 12 and/or the primary wireless communication node 34a, the primary wireless communication node 34a may authenticate the vehicle access device 14. For example, the primary wireless communication node 34a may request and/or receive authentication information from the wireless communication node 52 in order to determine whether the vehicle access device 14 is permitted to access the vehicle 12. In this regard, as described above, the vehicle access device 14 may receive permission to access and/or operate the vehicle from the vehicle control center 18. If 108 is true, the method may proceed to 110. If 108 is false, the method may return to 100.

At 110, the vehicle access device 14 may be wirelessly linked and/or paired to the vehicle 12. For example, the wireless communication node 52 of the vehicle access device 14 and the primary wireless communication node 34a of the vehicle 14 may share and store a link key (e.g., a pass code) in order to establish a secure connection between the nodes 52, 34a. In this regard, the primary wireless communication node 34a may also share the link key with the secondary wireless communication nodes 34b, 34c such that the secondary wireless communication nodes 34b, 34c are securely connected to the wireless communication node 52 of the vehicle access device 14.

At 112, the secondary wireless communication nodes 34b, 34c and/or the body control module 23 may be activated. In this regard, the wireless communication node 52 may activate the secondary wireless communication nodes 34b, 34c and/or the body control module 23 using one of the wired and/or wireless communication protocols described above.

At 114, the communication system 22 may initiate a calibration process. In particular, at 114, secondary wireless communication node 34b may transmit (e.g., advertise) information (e.g., pre-defined packets) and the secondary wireless communication node 34c may receive information (e.g., packets). In this regard, the primary wireless communication node 34a may instruct the secondary wireless communication node 34b to transmit (e.g., advertise) the pre-defined packets, and may instruct the secondary wireless communication node 34c to receive the packets. In some configurations, the communication system 22 may initiate the calibration process after an ignition (not shown) of the vehicle 12 has been cycled to an “OFF” position.

At 116, the secondary wireless communication node 34c may receive and/or determine a first received single strength indication (RSSI) value (e.g., a calibration value) corresponding to the secondary wireless communication node 34b. In particular, the secondary wireless communication node 34c may determine the first RSSI value based on the pre-defined packets transmitted by the secondary wireless communication node 34b. Determining the first RSSI value at 116 may also include filtering and/or smoothing the first RSSI value.

At 118, the first RSSI value may be sent to the primary wireless communication node 34a and/or stored in the secondary wireless communication node 34c. In this regard, the secondary wireless communication node 34c may include a memory for storing the first RSSI value. In some configurations, the memory may include a form of random access memory that is cleared by a power cycle or other reboot of the communication system 22. In other configurations, the memory may include a non-volatile memory that does not require power to maintain stored information, such as the first RSSI value.

At 120, the secondary wireless communication node 34c may transmit (e.g., advertise) information (e.g., pre-defined packets) and the secondary wireless communication node 34b may receive information (e.g., packets). In this regard, at 120, the primary wireless communication node 34a may instruct the secondary wireless communication nodes 34b, 34c to switch roles such that the secondary wireless communication node 34c transmits (e.g., advertises) pre-defined packets, and the secondary wireless communication node 34b receives the packets.

At 122, the secondary wireless communication node 34b may receive and/or determine a second RSSI value (e.g., a calibration value) corresponding to the secondary wireless communication node 34c. In particular, the secondary wireless communication node 34b may determine the second RSSI value based on the pre-defined packets transmitted by the secondary wireless communication node 34c. Determining the second RSSI value at 122 may also include filtering and/or smoothing the second RSSI value.

At 124, the second RSSI value may be sent to the primary wireless communication node 34a and/or stored in the secondary wireless communication node 34b. In this regard, the secondary wireless communication node 34b may include a memory for storing the second RSSI value. In some configurations, the memory may include a form of random access memory that is cleared by a power cycle or other reboot of the communication system 22. In other configurations, the memory may include a non-volatile memory that does not require power to maintain stored information, such as the second RSSI value.

At 126, the secondary wireless communication nodes 34b, 34c may deactivate and/or enter a sleep mode. In this regard, at 126, the calibration process may terminate and the primary wireless communication node 34a may instruct the secondary wireless communication nodes 34b, 34c to enter a sleep mode in order to conserve power within the vehicle 12. For example, instructing the secondary wireless communication nodes 34b, 34c to enter a sleep mode may conserve power within a battery (not shown) of the vehicle 12.

At 128, while the primary wireless communication node 34a is securely linked to the wireless communication node 52 of the vehicle access device 14, the wireless communication node 52 may advertise, and the primary wireless communication node 34a may receive, packets of information and/or a current transmit (Tx) power level used by the vehicle access device 14 to advertise the packets information. In this regard, at 128, the primary wireless communication node 34a may instruct the wireless communication node 52 to transmit the packets of information and/or the current Tx power level to the primary wireless communication node 34a. In particular, the wireless communication node 52 may instruct via a BLUETOOTH® specification, such as generic attribute (GATT) profile, the vehicle access device 14 to advertise the packets and the TX power level.

At 130, the secondary wireless communication nodes 34b, 34c may activate and search for and/or receive the packets of information and Tx power level sent at 128. In this regard, at 130, the packets of information and Tx power level may be sent to the secondary wireless communication nodes 34b, 34c from the vehicle access device 14. Upon activating at 130, the secondary wireless communication nodes 34b, 34c may also perform the calibration process (e.g., steps 114, 116, 118, 120, 122, 124, and/or 126) prior to searching for and/or receiving the packets of information and Tx power level sent at 128.

At 132, the secondary wireless communication nodes 34b, 34c may receive and/or determine various iterations of third and/or fourth RSSI values, respectively, corresponding to the vehicle access device 14. In this regard, the secondary wireless communication nodes 34b, 34c may determine each iteration of the third and fourth RSSI values based on the packets and/or Tx power level continuously transmitted by the vehicle access device 14. Determining the third and fourth RSSI values at 132 may also include filtering and/or smoothing the third and fourth RSSI values and storing the third and fourth RSSI values. As will be explained in more detail below, the third and fourth RSSI values may be used to approximate a distance between the vehicle access device 14 and the vehicle 12. In particular, the third and fourth RSSI values may be used as part of an input in determining which lookup table should be used to determine the location of the vehicle access device 14 relative to the vehicle 12.

At 134, the secondary wireless communication nodes 34b, 34c may transmit the third and fourth RSSI values, respectively, to the primary wireless communication node 34a. As will be explained in more detail, below, the third and fourth RSSI values may be used by the primary wireless communication node 34a as part of a localization strategy for the vehicle access device 14.

At 136, the vehicle access device 14 may transmit an acceleration and velocity value(s) to the primary wireless communication node 34a. In this regard, the gyroscope 48 may transmit angular velocity values (e.g., X-axis, Y-axis, and/or Z-axis angular velocity) corresponding to the vehicle access device 14, and the accelerometer 50 may transmit a linear acceleration value corresponding to the vehicle access device 14. In particular, at 136, the primary wireless communication node 34a may instruct the gyroscope 48 and/or the accelerometer 50 to transmit the angular velocity values and/or the linear acceleration values, such that the communication system 22 can determine various characteristics of the vehicle access device 14, such as a location, an angular and/or linear direction of movement, speed, and/or acceleration. For example, the angular velocity values and/or the linear acceleration values can be used to determine whether the vehicle access device 14 is moving toward the vehicle 12 or away from the vehicle 12. The angular velocity values and/or the linear acceleration values can also be used to determine an orientation of the vehicle access device 14 relative to the vehicle 12. For example, angular velocity values and/or the linear acceleration values can be used to determine whether an antenna (not shown) of the vehicle access device 14 is pointed toward or away from the vehicle 12.

At 138, the vehicle access device 14 may transmit weather, location, and other related information to the primary wireless communication node 34a. In particular, at 138, the environmental-monitoring application 46 may transmit, and the primary wireless communication node 34a may receive, the weather characteristics of a place in which the vehicle access device 14 is located. Other applications and/or modules (e.g., a GPS module) of the vehicle access device 14 may transmit other characteristics of the place in which the vehicle access device 14 is located. For example, the GPS module (not shown) may transmit information indicating whether the vehicle access device 14 is located indoor or outdoor.

At 140, the communication system 22 may create a lookup table of RSSI values and weather, location, and other information related to the vehicle access device 14. For example, at 140, the primary wireless communication node 34a may create a lookup table of the various third and fourth RSSI values corresponding to the weather and location information transmitted from the vehicle access device 14 at 138. The lookup table of third and fourth RSSI values corresponding to the weather and location information transmitted from the vehicle access device 14 can allow the communication system 22 to cross-reference in order to approximate a distance between the vehicle access device 14 and the vehicle 12.

At 141, the communication system 22 may determine the location of the vehicle access device 14. In particular, the communication system 22 may approximate the distance between the vehicle access device 14 and the vehicle 12 by cross-referencing various characteristics of the vehicle access device 14 (e.g., RSSI values, weather, acceleration, velocity, etc.) in the lookup table created at 140.

At 142, the communication system 22 may determine whether to allow the vehicle access device 14 to access the vehicle 12 based one or more of the distance between the vehicle access device 14 and the vehicle 12 approximated at 140, and the orientation and movement (e.g., angular and/or linear direction of movement, speed, and/or acceleration) of the vehicle access device 14 determined at 136. For example, if the distance between the vehicle access device 14 and the vehicle 12 is less than or equal to a predetermined threshold distance, and/or if the vehicle access device 14 is oriented and/or moving towards the vehicle 12, the communication system 22 may permit the vehicle access device 14 to access the vehicle 12. For example, the communication system 22 may permit the vehicle access device 14 to change the state of (e.g., unlock) the locks 24 and/or start the engine (not shown) of the vehicle 12.

With reference to FIG. 4, another method for determining a position of the vehicle access device 14 relative to the vehicle 12, and/or determining whether to permit the vehicle access device 14 to access the vehicle 12, is illustrated at 300. Except as otherwise provided herein, the method 300 may be similar to the method 100. In this regard, the method 300 may begin after a calibration process similar to the calibration process described relative to the method 100. For example, the method 300 may begin after completing steps 114, 116, 118, 120, 122, 124, and/or 126 of the method 100. As will be explained, the method 300 may allow the communication system 22 to recognize and adapt to changing conditions (e.g., weather) at the location of the vehicle access device 14 and/or the vehicle 12.

At 302, while the primary wireless communication node 34a is securely linked to the wireless communication node 52 of the vehicle access device 14, the wireless communication node 52 may advertise, and the primary wireless communication node 34a may receive, packets of information and/or the Tx power level used by the vehicle access device 14 to advertise the packets information. In this regard, at 302, the primary wireless communication node 34a may instruct the wireless communication node 52 to transmit the packets of information and/or the current Tx power level to the primary wireless communication node 34a. In particular, the wireless communication node 52 may instruct via a BLUETOOTH® specification, such as generic attribute (GATT) profile, the vehicle access device 14 to advertise the packets and the TX power level.

At 304, the secondary wireless communication nodes 34b, 34c may activate and search for and/or receive the packets of information and Tx power level sent at 302. In this regard, at 304, the packets of information and Tx power level may be sent to the secondary wireless communication nodes 34b, 34c from the vehicle access device 14.

At 306, the communication system 22 may complete the step(s) described at 136, above. At 308, the communication system 22 may complete the step(s) described at 138, above.

At 310, the communication system 22 may receive information related to a location of the vehicle 12. For example, at 310, the communication system 22 may receive information related to the weather at the location of the vehicle 12. In this regard, the vehicle may include various sensors (e.g., a precipitation sensor, a light sensor, a fog sensor, etc.; schematically represented by reference number 39 in FIGS. 1 and 2) for sensing and determining various weather-related characteristics at the location of the vehicle 12.

At 312, the communication system 22 may create a table of weather, location, and other information related to the vehicle 12. For example, at 312, the primary wireless communication node 34a may create a table of the various weather and/or location information transmitted from the vehicle 12 at 310. The table of weather and/or location information transmitted from the vehicle 12 can allow the communication system 22 to approximate a distance between the vehicle access device 14 and the vehicle 12.

At 314, the communication system 22 may determine whether to allow the vehicle access device 14 to access the vehicle 12 utilizing the information received at 306, 308, and/or 310. In particular, at 314, the communication system 22 may determine whether to allow the vehicle access device 14 to access the vehicle 12 by comparing the information in the table created at 308 to the information in the table created at 312. In this regard, if the information corresponding to the table created at 308 (e.g., information related to the weather at the location of the vehicle access device 14) matches the information corresponding to the table created at 312, the communication system 22 may permit the vehicle access device 14 to access the vehicle 12. For example, if the information transmitted at 306 indicates that a distance between the vehicle access device 14 and the vehicle 12 is greater than a predefined threshold distance, but the table created at 308 and the table created at 312 both indicate that the weather is rainy, the communication system 22 may permit the vehicle access device 14 to access the vehicle 12.

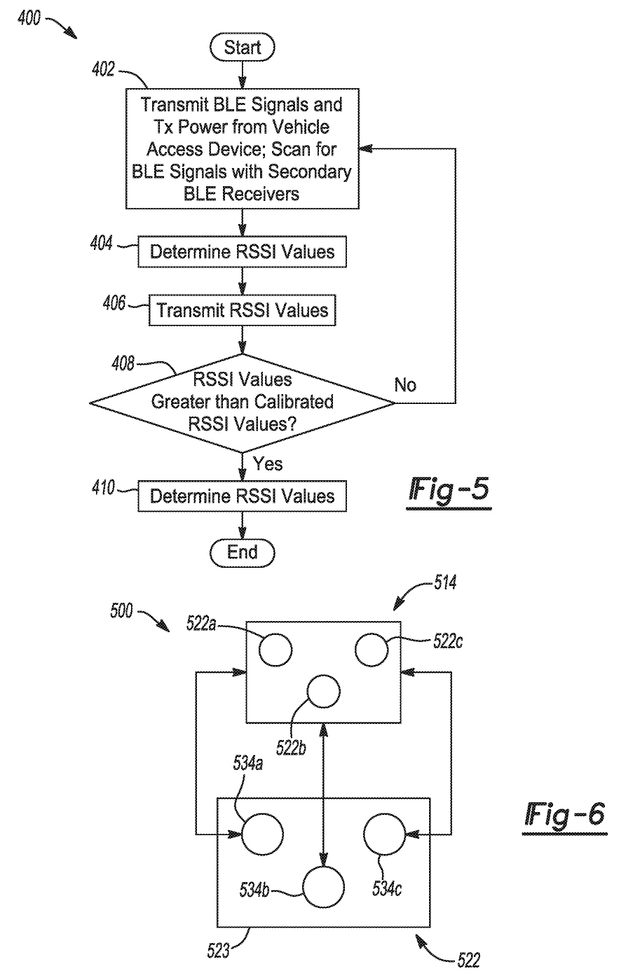

With reference to FIG. 5, another method for determining a position of the vehicle access device 14 relative to the vehicle 12, and/or determining whether to permit the vehicle access device 14 to access the vehicle 12, is illustrated at 400. Except as otherwise provided herein, the method 400 may be similar to the methods 100 and/or 300. As will be explained in more detail below, the method 400 may allow the vehicle communication system 10 to reduce an overall power consumption of the primary wireless communication node 34a. Moreover, the method 400 may allow the vehicle communication system 10 to support a larger variety (e.g., models) of vehicle access devices 14, and allow for a more efficient vehicle communication system 10 by utilizing a BLE application programming interface on the vehicle access device 14.

At 402, the secondary wireless communication nodes 34b, 34c may scan and/or search for, and the wireless communication node 52 of the vehicle access device 14 may transmit, BLE packets. In this regard, the primary wireless communication node 34a may instruct the secondary wireless communication nodes 34b, 34c to scan for the BLE packets.

At 404, each of the secondary wireless communication nodes 34b, 34c may receive and/or determine an RSSI value corresponding to the wireless communication node 52 of the vehicle access device 14. In particular, the secondary wireless communication nodes 34b, 34c may determine the RSSI values based on the packets transmitted by the wireless communication node 52. Determining the RSSI values at 404 may also include filtering and/or smoothing the RSSI value.

At 406, the primary wireless communication node 34a may receive the RSSI values. In particular, the secondary wireless communication nodes 34b, 34c may transmit, and the primary wireless communication node 34a may receive, the RSSI values.

At 408, the communication system 22 may compare the RSSI values generated at 404 to the RSSI values generated during a calibration process. In particular, the communication system 22 may determine whether the RSSI values generated at 404 are greater than the RSSI values generated during steps 114, 116, 118, 120, 122, 124, and/or 126 of the method 100. If 408 is true, the vehicle communication system 10 may determine that the vehicle access device 14 is located within the vehicle 12, and may permit the user to access the vehicle 12 with the vehicle access device 14. For example, if 408 is true, the communication system 22 may permit the vehicle access device 14 to start the engine of the vehicle 12 at 410. If 408 is false, the vehicle communication system 10 may determine that the vehicle access device 14 is located outside of the vehicle 12, and may prohibit the user from accessing the vehicle 12 with the vehicle access device 14. For example, if 408 is false, the communication system 22 may prohibit the vehicle access device 14 from starting the engine of the vehicle 12.

With reference to FIG. 6, another vehicle communication system 500 is illustrated. The vehicle communication system 500 may implement, or otherwise operate using, the methods 100, 300, and/or 400 described above. In this regard, the vehicle communication system 500 may include a vehicle access device 514 and a communication system 522.

The communication system 522 may be disposed within the vehicle 12 and may include a communication control module 523. The communication control module 523 may include one or more wireless communication nodes 534a-c. For example, in some configurations, the communication control module 523 may include three wireless communication nodes 534a-c. In particular, the communication control module 523 may include an ultra-high frequency (UHF) communication node 534a, a BLE communication node 534b, and/or a near field communication (NFC) node 534c. As illustrated, the UHF communication node 534a, the BLE communication node 534b, and the NFC node 534c may all be located within the same communication control module 523. Locating the UHF communication node 534a, the BLE communication node 534b, and the NFC node 534c within the same communication control module 523 can reduce the material cost and/or packaging size of the communication system 522.

The vehicle access device 514 may be similar to the vehicle access device 14, except as otherwise provided herein. The vehicle access device 514 may include one or more wireless communication nodes 522a-c. For example, in some configurations, the vehicle access device 514 may include three wireless communication nodes 522a-c. In particular, the vehicle access device 514 may include an ultra-high frequency (UHF) communication node 522a, a BLE communication node 522b, and/or a near field communication (NFC) node 522c. The UHF communication node 522a, the BLE communication node 522b, and the NFC node 522c may be in communication with the control module 523 of the vehicle. In particular, the UHF communication node 534a, the BLE communication node 534b, and the NFC node 534c may wirelessly communicate with the UHF communication node 522a, the BLE communication node 522b, and the NFC node 522c, respectively, of the vehicle access device 514.

The following Clauses provide an exemplary configuration for the method of determining a location of a vehicle access device and related system described above.

Clause 1: A method for determining a location of a vehicle access device relative to a vehicle, the method including transmitting information from the vehicle access device to the vehicle, determining a received signal strength indication value of the vehicle access device, transmitting the received signal strength indication value from a first wireless communication node to a second wireless communication node, the first wireless communication node and the second wireless communication node disposed on the vehicle, and comparing the received signal strength indication value of the vehicle access device to a received signal strength indication value of the first wireless communication node.

Clause 2: The method of Clause 1, wherein the vehicle access device includes one of a smartphone, a smart watch, and a tablet computing device.

Clause 3: The method of Clause 1, wherein the information includes weather information related to a location of the vehicle access device.

Clause 4: The method of Clause 1, further comprising permitting the vehicle access device to access the vehicle when the received signal strength indication value of the vehicle access device is greater than or equal to a predetermined value.

Clause 5: The method of Clause 4, wherein permitting the vehicle access device to access the vehicle includes permitting the vehicle access device to activate an engine of the vehicle.

Clause 6: The method of Clause 1, further comprising permitting the vehicle access device to access the vehicle when the received signal strength indication value of the vehicle access device indicates that the vehicle access device is disposed within the vehicle.

Clause 7: The method of Clause 1, further comprising comparing the received signal strength indication value of the vehicle access device to a received signal strength indication value of a third wireless communication node disposed on the vehicle.

Clause 8: The method of Clause 1, further comprising: transmitting weather-related information from a sensor disposed on the vehicle to the first wireless communication node, and comparing the weather-related information from the sensor disposed on the vehicle to the information transmitted from the vehicle access device to the vehicle.

Clause 9: The method of Clause 1, wherein the first wireless communication node and the second wireless communication node are Bluetooth® low energy communication nodes.

Clause 10: The method of Clause 1, further comprising transmitting a current power transmit value of the vehicle access device to the first wireless communication node.

Clause 11: The method of Clause 1, wherein comparing the received signal strength indication value of the vehicle access device to a received signal strength indication value of the first wireless communication node further comprises using one of a first lookup table and a second lookup table to determine a location of the vehicle access device.

Clause 12: The method of Clause 11, wherein the first lookup table corresponds to a first environmental condition and the second lookup table corresponds to a second environmental condition that is different than the first environmental condition.

Clause 13: A system for determining a location of a vehicle access device, the system including a vehicle having: a body including a support portion, a first access door, a second access door, and a communication system disposed on the vehicle. The communication system includes a first wireless communication node disposed on the first access door, a second wireless communication node disposed on the second access door, and a third wireless communication node disposed on the support portion, the third wireless communication node configured to communicate with the first and second wireless communication nodes.

Clause 14: The system of Clause 13, wherein the first, second, and third wireless communication nodes are configured to communicate with a vehicle access the device.

Clause 15: The system of Clause 14, wherein the vehicle access the device includes one of a smartphone, a smart watch, and a tablet computing device.

Clause 16: The system of Clause 13, wherein the first access door includes a driver's side door.

Clause 17: The system of Clause 13, wherein the second access door includes a passenger's side door.

Clause 18: The system of Clause 13, wherein the support portion includes a C-pillar.

Clause 19: A system for communicating between a vehicle and a vehicle access device, the system including a first communication module having a first ultra-high frequency communication node, a first Bluetooth® low energy communication node, and a first near-field communication node.

Clause 20: The system of Clause 19, further including a second communication module having a second ultra-high frequency communication node in communication with the first ultra-high frequency communication node, a second Bluetooth® low energy communication node in communication with the first Bluetooth® low energy communication node, and a second near-field communication node in communication with the first near-field communication node.

Clause 21: The system of Clause 20, further comprising a vehicle including the first communication module, and a vehicle access device including the second communication module.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

1. A method for determining a location of a vehicle access device relative to a vehicle, the method comprising:
transmitting information from the vehicle access device to the vehicle;
determining a received signal strength indication value of the vehicle access device;
transmitting the received signal strength indication value from a first wireless communication node to a second wireless communication node, the first wireless communication node and the second wireless communication node disposed on the vehicle; and
comparing the received signal strength indication value of the vehicle access device to a received signal strength indication value of the first wireless communication node.

2. The method of claim 1, wherein the vehicle access device includes one of a smartphone, a smart watch, and a tablet computing device.

3. The method of claim 1, wherein the information includes weather information related to a location of the vehicle access device.

4. The method of claim 1, further comprising permitting the vehicle access device to access the vehicle when the received signal strength indication value of the vehicle access device is greater than or equal to a predetermined value.

5. The method of claim 4, wherein permitting the vehicle access device to access the vehicle includes permitting the vehicle access device to activate an engine of the vehicle.

6. The method of claim 1, further comprising permitting the vehicle access device to access the vehicle when the received signal strength indication value of the vehicle access device indicates that the vehicle access device is disposed within the vehicle.

7. The method of claim 1, further comprising comparing the received signal strength indication value of the vehicle access device to a received signal strength indication value of a third wireless communication node disposed on the vehicle.

8. The method of claim 1, further comprising:
transmitting weather-related information from a sensor disposed on the vehicle to the first wireless communication node; and
comparing the weather-related information from the sensor disposed on the vehicle to the information transmitted from the vehicle access device to the vehicle.

9. The method of claim 1, wherein the first wireless communication node and the second wireless communication node are Bluetooth low energy communication nodes.

10. The method of claim 1, further comprising transmitting a current power transmit value of the vehicle access device to the first wireless communication node.

11. The method of claim 1, wherein comparing the received signal strength indication value of the vehicle access device to a received signal strength indication value of the first wireless communication node further comprises:
using one of a first lookup table and a second lookup table to determine a location of the vehicle access device.

12. The method of claim 11, wherein the first lookup table corresponds to a first environmental condition and the second lookup table corresponds to a second environmental condition that is different than the first environmental condition.

13. A system for determining a location of a vehicle access device, the system comprising:
a vehicle including:
a body having a support portion;
a first access door;
a second access door;
a communication system disposed on the vehicle, the communication system including:
a first wireless communication node disposed on the first access door;
a second wireless communication node disposed on the second access door; and
a third wireless communication node disposed on the support portion, the third wireless communication node configured to communicate with the first and second wireless communication nodes.

14. The system of claim 13, wherein the first, second, and third wireless communication nodes are configured to communicate with a vehicle access the device.

15. The system of claim 14, wherein the vehicle access the device includes one of a smartphone, a smart watch, and a tablet computing device.

16. The system of claim 13, wherein the first access door includes a driver's side door.

17. The system of claim 13, wherein the second access door includes a passenger's side door.

18. The system of claim 13, wherein the support portion includes a C-pillar.

19. A system for communicating between a vehicle and a vehicle access device, the system comprising:
a first communication module including a first ultra-high frequency communication node, a first Bluetooth low energy communication node, and a first near-field communication node.

20. The system of claim 19, further comprising:
a second communication module including a second ultra-high frequency communication node in communication with the first ultra-high frequency communication node, a second Bluetooth low energy communication node in communication with the first Bluetooth low energy communication node, and a second near-field communication node in communication with the first near-field communication node.

21. The system of claim 20, further comprising a vehicle including the first communication module, and a vehicle access device including the second communication module.
